(19) United States
(12) Patent Application Publication
(10) Pub. No.: US 2007/0178855 A1
(43) Pub. Date: Aug. 2, 2007

(54) Large scale bi-directional user terminal with configurable transmission frequencies

(76) Inventors: Dominique Lo Hine Tong, Rennes (FR); Jean-Yves Le Naour, Pace (FR); Corinne Nicolas, La Chappelle Des Fougeretz (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/579,044

(22) PCT Filed: Apr. 4, 2005
(86) PCT No.: PCT/EP05/51504

§ 371 Date: Oct. 30, 2006

(30) Foreign Application Priority Data
Apr. 29, 2004 (FR) 04/50835

(51) Int. Cl. H04B 1/04; H01Q 11/12

(52) U.S. Cl. 455/118

(57) ABSTRACT

The invention proposes an upgradeable product enabling a single circuit to be produced and very easily configured in the factory for a lower production cost. The minimisation of the industrialisation costs is achieved by an increase of production volumes. An outdoor unit of a reception terminal including a return channel, comprises a band-pass filtering means that allows the transposed signals found in a transmission bandwidth to pass, and a rejector filtering means that rejects at least one frequency found in the transmission bandwidth, the rejector filtering means being neutralised when neither the frequency defined in the oscillator nor a multiple frequency of the defined frequency is found in the transmission bandwidth.

The invention relates to a wide broadcast bidirectional user terminal with configurable transmission frequencies.

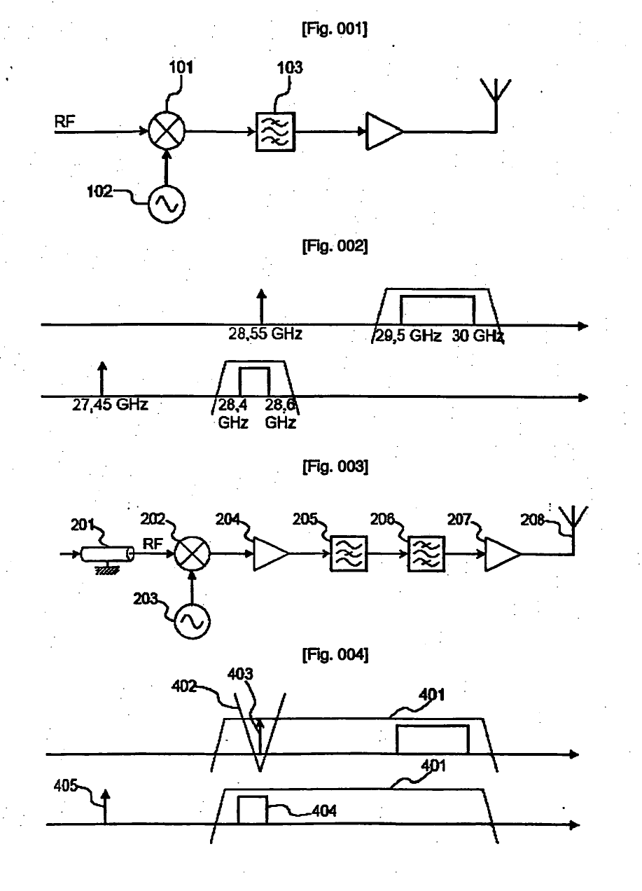

FIG. 1 illustrates a standard architecture example of a Ka band conversion and transmission block (hereafter BUC, for Block Up Conversion) placed in an outdoor transmission unit (hereafter ODU, for “OutDoor Unit”) An RF signal, for example in the 0.95-1.45 GHz band from an indoor unit (hereafter IDU, for InDoor Unit) is transposed into the Ka band by implementing a subharmonic mixer 101 and a local oscillator 102 operating at the Ku band. A highly selective band-pass filtering 103 is required in particular to eliminate the residual Ka band component that is twice the frequency of the local oscillator, which must not be radiated by the terminal.

For implementation reasons, operators require a Ka band application with a wideband transmission that can be selected from two frequency bands, for example the 28.4-28.6 GHz band and the 29.5-30 GHz band. Either of these bands being assigned to the user according to his requirements and/or his geographical location. For such an arrangement, the transmission bands correspond to the local oscillator frequencies of the BUC, respectively 13.725 GHz and 14.275 GHz. The unwanted components to filter are then at 27.45 and 28.55 GHz. FIG. 2 illustrates the frequency plans corresponding to the two Ka band frequency

es emitted (highband and lowband) and it can be seen that the double frequency of the local oscillator for the highband lies within the lowband. One approach typically implemented in this case is to propose two types of separate terminals capable of covering one or other of the frequency bands, this to the detriment of the cost of the terminal with management of several product versions.

The invention proposes an upgradeable product enabling a single circuit to be produced and very easily configured in the factory for a lower production cost. Hence, the minimisation of the industrialisation costs is achieved by an increase of production volumes, which are automatically doubled. Moreover, several operators can use the same product.

The invention is an outdoor unit of a reception terminal including a return channel. The return channel comprises a local oscillator providing a signal having a defined frequency. A transposition means transposes a signal to be transmitted by using the signal provided by the local oscillator. A band-pass filtering means allows the transposed signals found in a transmission bandwidth to pass. A rejector filtering means rejects at least one frequency found in the transmission bandwidth, the rejector filtering means being neutralised when neither the frequency defined in the oscillator nor a multiple frequency of the defined frequency is found in the transmission bandwidth.

Preferentially, the rejector filter is constituted by resonant cavities coupled to a waveguide by means of slots. The rejector filter is neutralised by neutralising the said slots. The slots are neutralised by welding conductive pads onto the slots. The outdoor unit comprises a dielectric substrate placed between an upper cover and a lower cover. The waveguide is positioned in the lower cover and the resonant cavities are positioned in the upper cover, the coupling being made by means of slots positioned in at least one ground plane integral with the substrate, the said ground plane being located between the waveguide and the resonant cavities.

The invention will be better understood, and other specific features and advantages will emerge from reading the following description, the description making reference to the annexed drawings wherein:

FIG. 1 shows a BUC architecture according to the prior art,

FIG. 2 shows the transmission frequency plans of a system using two sub-bands,

FIG. 3 shows an embodiment of a BUC according to the invention,

FIG. 4 shows the frequency plans used according to the configuration of the terminal,

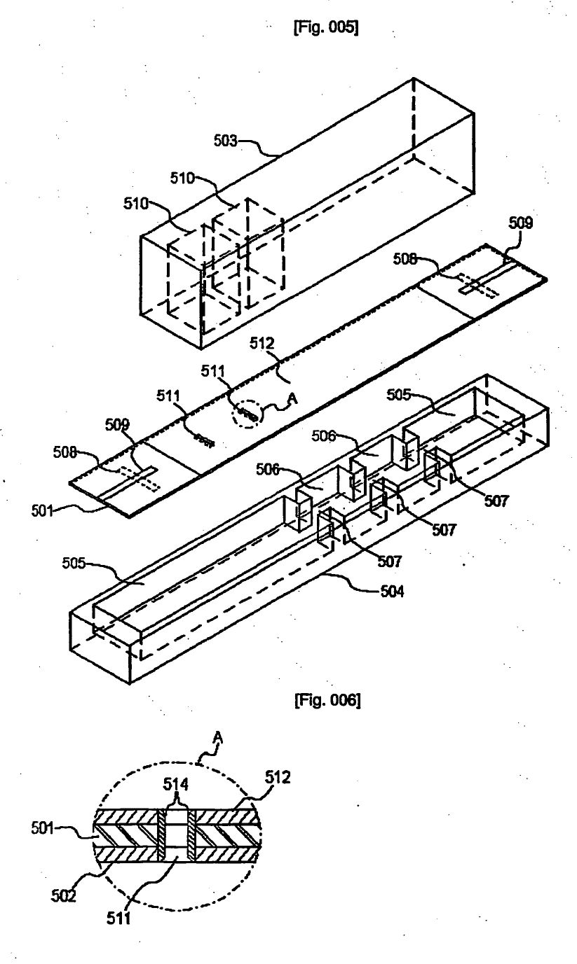

FIG. 5 shows a preferred embodiment of the filters implemented in the example of FIG. 3,

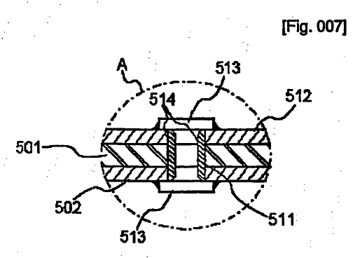

FIGS. 6 and 7 show the two configuration possibilities of the band rejector filter implemented in FIG. 5.

FIG. 3 illustrates the architecture of a BUC according to the invention capable of covering the two previously cited frequency bands, 28.4-28.6 GHz and 29.5-30 GHz. The BUC receives an RF signal in the intermediate band, for example in the 0.95-1.45 GHz band, from an indoor unit (not shown) by means of a coaxial cable 201. The BUC comprises a subharmonic mixer 202 and a local oscillator 203. A first amplifier 204 amplifies the output signal of the mixer 202 and sends it to the filtering means. The filtering means are constituted according to the invention by a rejector filter 205 and a band-pass filter 206. A second amplifier 207 positioned after the filtering means amplifies the filtered signal to send it to the antenna 208.

In order to obtain a lower production cost, the same circuit will be realised with only minor modifications to cover each of the two bands. Firstly, the local oscillator 203 is a dielectric resonator oscillator that can provide a signal either at the frequency of 13.725 GHz, or at the frequency of 14.275 GHz. The oscillator can be of the mono-frequency type with frequency adjustment at one or other of the two frequencies. However, it is possible to use a bi-frequency dielectric oscillator controlled by a switch, for example an oscillator as described in the application EP-A-1 267 481.

However, the filtering means must be realised in such manner that the two frequency bands can pass while rejecting the disturbance harmonic corresponding to twice the local oscillator frequency with a high attenuation. It should be noted that such filtering means are generally implanted on the circuit when a filter using microstrip technology is involved and possibly in the shielding caps if a waveguide technology is implemented. The use of such technologies for filters imposes a circuit specific to each filter, which does not optimise the production costs. According to the invention, a rejector filter 205 and a unique band-pass filter 206 are implemented irrespective of the configuration, which instantly enables the production volumes to be doubled for the circuit parts and cover. Those skilled in the art will note that the order of these two filters is not significant, what is important is to have the two filters in series. The band-pass filter 206 has a bandwidth that lets through both the highband (29.5-30 GHz) and the lowband (28.4-28.6 GHz). The rejector filter 205 is attuned to twice the frequency of the local oscillator when the oscillator is positioned to carry out the transposition into the highband, that is the frequency of 28.55 GHz located within the band-pass filter 206. Neutralisation means will enable the rejector filter 205 to be neutralised or not according to the operating frequency range required.

FIG. 4 diagrammatically shows the operation in both configuration cases. In the highband configuration, the template 401 of the band-pass filter 206 combines with template 402 of the rejector filter 205 to remove the local oscillator leak 403 positioned in the bandwidth of the band-pass filter 206. In the lowband configuration, only the template 401 of the band-pass filter 206 remains, the lowband 404 can pass and the local oscillator leak 405 is rejected by the band-pass filter 206.

To obtain a high attenuation of the oscillator leaks, it is preferable to have waveguide filters. FIG. 5 shows an exploded view of an embodiment of the waveguide filters. FIGS. 6 and 7 show the neutralisation means of the rejector filter 205 in detail. A dielectric substrate 501 features a ground plane 502 on its lower surface and, on its upper surface, a microstrip technology circuit that is not shown so as not to complicate the figures unnecessarily. The substrate 501 is positioned between an upper cover 503 and a lower cover 504 that provides the shielding of the circuit placed on the substrate 501. The substrate 501 is a conventional substrate matched to the operating frequency. The covers 503 and 504 are metal covers or conductive or metallized plastic covers and are produced for example by moulding. As is known, waveguide elements can be realized in the covers that come into contact with the substrate. Hence, the lower cover 504 comprises a waveguide 505 in which the cavities 506 coupled with the irises 507 form the band-pass filter 206. The waveguide 505 is closed off by the ground plane 502. The coupling of the waveguide is provided by two coupling zones where slots 508 are made in the ground plane 502. Microstrip lines 509 are positioned above the slots 508 to provide the coupling, according to a known technique, to the microstrip circuit placed on the substrate 501.

The rejector filter 205 is constituted by resonant cavities 510 located in the upper cover 503 and coupled to the waveguide 505 by means of coupling slots 511. A reduced ground plane 512 is placed on the upper surface of the substrate 501 to provide the electrical seal for the resonant cavities 510. The coupling slots 511 are realized by perforating the substrate 501 and the ground planes 502 and 512 then a metallization 514 of these slots is carried out according to a known technique. The systematic realisation of the slots can obtain the same circuit to be realized independently from the operating frequency band.

The dimensioning of the band-pass filter 206 and the rejector filter 205 is obtained according to a known technique in order to obtain the required filtering characteristics.

The rejector filter 205 is therefore neutralised by neutralising the coupling between the waveguide and the resonant cavities by welding covering pads 513 on the coupling pads 511 as shown in FIG. 7. The sealing pads 513 are simple conductive pads with a very low cost. Preferentially, a pad 513 is placed on each side of the substrate 501 but a pad 513 placed on only one side may suffice. Hence, the configuration can thus be achieved very simply by adding or not adding the pads 513 as shown in detail A of FIGS. 6 and 7.

Many variants are possible. If the filtering constraints are lower, it is possible to have recourse to a band-pass filter realized using another technology. However, if another technology is used for the rejector filter 205, the appropriate neutralisation means must be used. In the preferred example, a subharmonic mixer is used and the oscillator leak is consequently located at twice the oscillation frequency. If a conventional mixer is used, the oscillator leak is located at the frequency of the oscillator. The frequency rejected by the rejector filter must be attuned to the frequency of the oscillator or to a multiple of this frequency according to the type of mixer used.

1. Outdoor unit of a reception terminal including a return channel, wherein the return channel comprises:
a local oscillator providing a signal having a defined frequency,
a transposition means that transposes a signal to be transmitted using the signal provided by the local oscillator,
a band-pass filtering means that allows the transposed signals found in a transmission bandwidth to pass, and
a rejector filtering means that rejects at least one frequency found in the transmission bandwidth, the rejector filtering means being neutralised when neither the frequency defined in the oscillator nor a multiple frequency of the defined frequency is found in the transmission bandwidth.

2. Outdoor unit according to claim 1, wherein the rejector filter is constituted by resonant cavities coupled to a waveguide by means of slots, and in that the rejector filter is neutralised by neutralising the said slots.

3. Outdoor unit according to claim 2, which comprises dielectric substrate placed between an upper cover and a lower cover, wherein the waveguide is placed in the lower cover and the resonant cavities are placed in the upper cover, the coupling being obtained by means of slots placed in at least one ground plane integral with the substrate, the said ground plane being located between the waveguide and the resonant cavities.

4. Outdoor unit according to claim 2, wherein the slots are neutralised by welding conductive pads on the slots.
